(19) United States
(12) Patent Application Publication
(10) Pub. No.: US 2016/0178089 A1
(43) Pub. Date: Jun. 23, 2016

(54) WIRE HARNESS CLIP WITH INTEGRAL WIRE RETAINERS

(71) Applicant: FORD GLOBAL TECHNOLOGIES, LLC, Dearborn, MI (US)

(72) Inventor: Shailendra Yadav, Northville, MI (US)

(21) Appl. No.: 14/572,945

(22) Filed: Dec. 17, 2014

(51) Int. Cl. F16L 3/08; F16L 3/137; F16L 3/12; F16L 3/10

(52) U.S. Cl. CPC F16L 3/08; F16L 3/1008; F16L 3/137; F16L 3/1222

(57) ABSTRACT

A wire harness clip includes an elongated wire support, a plurality of wire retainers provided at spaced locations on the elongated wire support and a mounting stud that projects from the elongated wire support.

### TECHNICAL FIELD

This document relates generally to clips for mounting cables, wires, tubes and pipes to a support structure such as a motor vehicle body.

### BACKGROUND

Various clips have been developed in the art to mount cables, wires, tubes or pipes to a body of a motor vehicle. In one prior art embodiment illustrated in FIG. 1, the clip C comprises an elongated wire support S and a mounting stem M of a so-called fir tree or Christmas tree shape with spaced ridges that lockingly snaps through an aperture in a vehicle body to engage a body or panel surface. Tape such as insulated electrical adhesive tape T is utilized to hold the wire W on the elongated wire support S.

While useful for its intended purpose, this prior art design suffers from several drawbacks. First, the taping process adds to assembly time and cost. Second, the taping fixes the wire W to the elongated wire support S. Thus, there is no free sliding movement of the wire W with respect to the support S. Where the clip C is secured to a moving mechanism such as a front seat frame, this fixing of the wire W to the supports requires the use of an additional length of wire to accommodate the movement.

This document relates to a new and improved wire harness clip incorporating a plurality of integral wire retainers that allow one to quickly and easily secure a wire in the clip. Advantageously, this is accomplished while also allow sliding movement of the wire with respect to the clip. Such a device is particularly useful when the clip is mounted to a mechanism such as a front seat frame as it does not restrict movement of the frame, allows the use of an overall shorter length of wire when compared to the prior art clip C wherein the wire W is fixed by tape T to the clip and reduces assembly costs by eliminating the taping step.

### SUMMARY

In accordance with the purposes and benefits described herein, a wire harness clip is provided. That wire harness clip comprises an elongated wire support, a plurality of wire retainers provided at spaced locations on that support and a mounting stud projecting from the elongated wire support.

In one possible embodiment, the elongated wire support includes a wire abutment surface and a plurality of wire retainers are aligned to engage and hold a wire on the abutment surface.

At least one wire retainer of the plurality of wire retainers includes opposed flexible flanges. The opposed flanges are arcuate and curved toward each other. Further a gap is provided between the opposed arcuate flanges.

In one possible embodiment, each of the opposed flanges is integrally molded with the elongated wire support and includes a base at the elongated wire support and a tip adjacent the gap.

The opposed bases are separated by a distance D₁ and the opposed tips are separated by a distance D₂ where D₁>D₂.

Further a wire held in the clip has a diameter D₃ where D₁>D₃>D₂ so that the wire is captured between the opposed flanges but has clearance to slide along the wire abutment surface within the opposed flanges.

In another possible embodiment, the mounting stud projects from a mounting side of the elongated wire support. That mounting side is opposite the wire abutment surface and the plurality of wire retainers. Further the mounting stud includes a series of aligned frustoconical ribs.

In accordance with an additional aspect, a wire harness clip comprises (a) an elongated wire support having a longitudinal axis, (b) a plurality of retainers that capture and hold a wire aligned on the elongated wire support while allowing the wire to slide along the longitudinal axis with respect to the elongated wire support and (c) a mounting stem projecting from the elongated wire support.

In the following description, there are shown and described several preferred embodiments of the wire harness clip. As it should be realized, the wire harness clip is capable of other, different embodiments and its several details are capable of modification in various, obvious aspects all without departing from the clip as set forth and described in the following claims. Accordingly, the drawings and descriptions should be regarded as illustrative in nature and not as restrictive.

### BRIEF DESCRIPTION OF THE DRAWING FIGURES

The accompanying drawing Figures incorporated herein and forming a part of the specification, illustrate several aspects of the wire harness clip and together with the description serve to explain certain principles thereof. In the drawing figures:

FIG. 1 is a perspective view of a prior art wire harness clip incorporating insulated electrical adhesive tape to secure the wire to the clip.

FIG. 2 is a perspective view of the wire harness clip that is the subject of this document. The clip incorporates a plurality of integral wire retainers as shown.

FIG. 3 is a perspective view of the wiring harness clip similar to FIG. 2 but showing a wire captured on the elongated wire support by the plurality of wire retainers.

FIG. 4 is an end view showing how the wire W is captured on the elongated wire support by the plurality of wire retainers while incorporating the necessary clearance to allow the wire to freely slide longitudinally with respect to the wire support.

Reference will now be made in detail to the present preferred embodiments of the wiring harness clip, examples of which are illustrated in the accompanying drawing figures.

### DETAILED DESCRIPTION

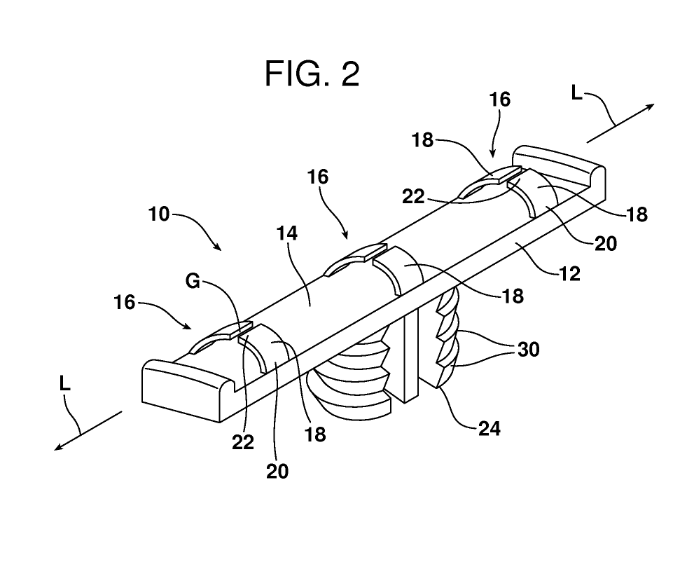

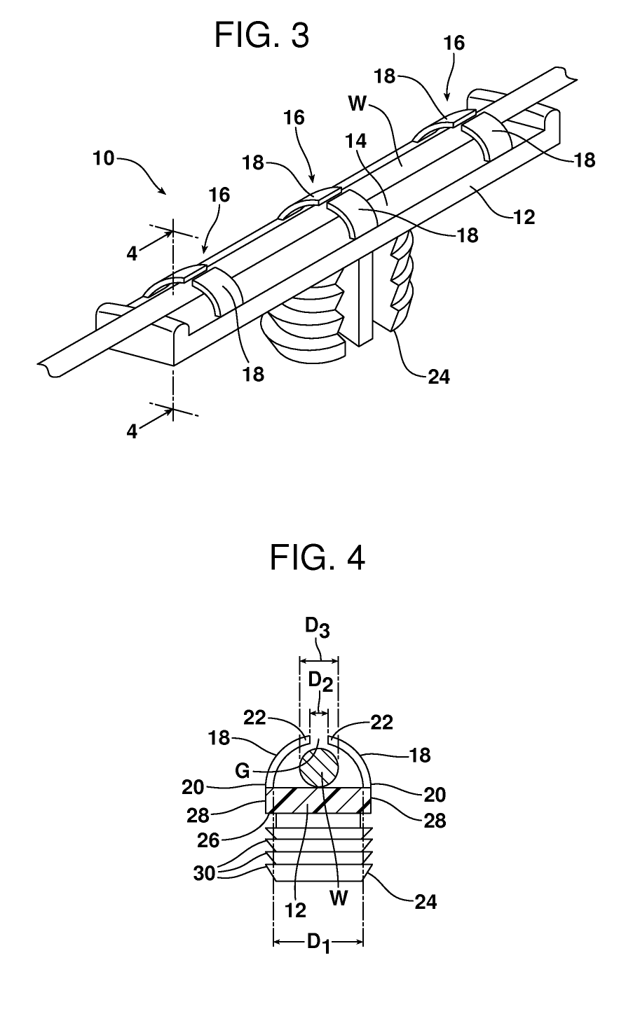

Reference is now made to FIGS. 2-4 illustrating the wire harness clip 10. That clip 10 includes an elongated wire support 12 having a longitudinal axis L and a wire abutment surface 14. The clip 10 also includes a plurality of wire retainers 16 provided at spaced locations along the elongated wire support 12. For purposes of this document and the following claims, the term “wire” should be broadly interpreted to include one or more electrical wires, electrical cables, tubes and pipes such as may need to be secured to a support structure such as the body of a motor vehicle.

In the illustrated embodiment each of the wire retainers 16 comprises opposed flexible flanges or lips 18. The opposed flanges 18 are arcuate and curve toward each other from a base 20 at the elongated wire support 12 to a tip 22. A gap G is formed between the two tips 22 of each opposed set of arcuate flanges 18.

As best illustrated in FIG. 4, the opposed bases 20 are separated by a distance D₁ while the opposed tips 22 are separated by a distance D₂ (that is: the gap G has a distance D₂) where D₁>D₂.

A mounting stud 24 projects from a mounting side 26 of the elongated wire support 12. In the illustrated embodiment the mounting side 26 is opposite the wire abutment surface 14 and the plurality of wire retainers 16. It should be appreciated, however, that if required or preferred for any particular application, the mounting stud 24 could project from either or both of the sidewalls 28 of the elongated wire support 12 in an alternative embodiment.

In the illustrated embodiment the mounting stud 24 includes a series of aligned frustoconical ribs 30 and is of the fir tree or Christmas tree type that may be easily secured in an appropriately sized aperture in a component or body of a motor vehicle.

The wire harness clip 10 is relatively inexpensive to produce and may, for example, be molded from substantially any appropriate material. Appropriate materials include but are not necessarily limited to a polyamide such as nylon. Further it should be appreciated that the wire retainers 16 may be integrally molded with the elongated wire support 12 and the mounting stud 24 so that the wire harness clip 10 is of one-piece construction.

The wire harness clip 10 is easy to use. First the mounting stud 24 is aligned over a mounting aperture in the vehicle body or vehicle component to which it is to be mounted and pressure is then applied to force the stud into the aperture. The longitudinal axis L of the elongated wire support 12 is then oriented as desired and the wire W to be held in the wire harness 10 is pushed through the gap G of each wire retainer 16. As this is done, the flexible flanges or lips 18 spread to allow the passage of the wire W and then returned to their original position through resilient spring memory closing over the wire and securing the wire in position on the support 12.

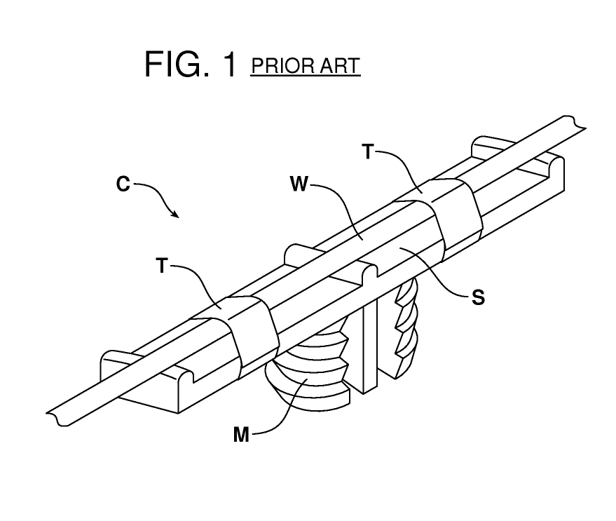

As illustrated in FIG. 4, the wire W held in the clip 10 may have a diameter D₃ which is greater than the width D₂ of the gap G between the tips 22 of the opposed flanges 18 when they return by resilient memory to their home position. Thus, the wire W is captured between the flanges 18 on the wire abutment surface 14. However, where the distance D₁ between the bases 20 of opposed flanges 18 is sufficient, clearance exists to allow the wire W to slide longitudinally with respect to the wire abutment surface 14 of the elongated wire support 12 along the longitudinal axis L. Thus it should be appreciated that the wire harness clip 10 is designed to maintain the wire W on the elongated wire support 12 while allowing the wire W to slide along the longitudinal axis L with respect to the support. As such the wire harness clip 10 is particularly useful for mounting and capturing a wire W in a desired position on a component of the vehicle, such as a seat frame of a driver or passenger seat where the wiring harness must allow for fore and aft movement that is limited in nature. The prior art wire harness clip C as illustrated in FIG. 1 includes insulated electrical adhesive tape that fixes the wire W directly to the clip C and will not accommodate such movement absent the provision of an additional length of wire not required when using the wire harness clip of the present 10. Thus this represents a significant advantage over the prior art design for seat construction and like applications.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A wire harness clip, comprising:
an elongated wire support;
a plurality of wire retainers provided at spaced locations on said elongated wire support, wherein at least one wire retainer of said plurality of wire retainers includes opposed flexible flanges, wherein each of the opposed flexible flanges include a base at said elongated wire support, and wherein opposed bases are separated by a distance D₁; and
a mounting stud projecting from said elongated wire support.

2. The clip of claim 1, wherein said elongated wire support includes a wire abutment surface and said plurality of wire retainers are aligned to engage and hold a wire on said wire abutment surface.

3. (canceled)

4. The clip of claim 2, wherein said opposed flanges are arcuate and curve toward each other.

5. The clip of claim 4, further including a gap between said opposed arcuate flanges.

6. The clip of claim 5, wherein each of said opposed flanges is integrally molded with said elongated wire support and includes a tip adjacent said gap.

7. The clip of claim 6, wherein opposed tips are separated by a distance D₂ where D₁>D₂.

8. The clip of claim 7, wherein a wire held in said clip has a diameter D3 and D₁>D₃>D₂ so that said wire is captured between said opposed flanges but has clearance to slide along said wire abutment surface within said opposed flanges.

9. The clip of claim 8, wherein said mounting stud projects from a mounting side of said elongated wire support.

10. The clip of claim 9, wherein said mounting side is opposite said wire abutment surface and said plurality of wire retainers.

11. The clip of claim 10, wherein said mounting stud includes a series of aligned frustoconical ribs.

12. A wire harness clip, comprising:
an elongated wire support having a longitudinal axis extending between opposed sidewalls;
a plurality of wire retainers that capture and hold a wire aligned on said elongated wire support while allowing said wire to slide along said longitudinal axis with respect to said elongated wire support; and
a mounting stud projecting from said elongated wire support.

13. The clip of claim 12, wherein said elongated wire support includes a wire abutment surface and said plurality of wire retainers are aligned to engage and hold a wire on said wire abutment surface.

14. The clip of claim 13, wherein at least one wire retainer of said plurality of wire retainers includes opposed flexible flanges.

15. The clip of claim 14, wherein said opposed flanges are arcuate and curve toward each other.

16. The clip of claim 15, further including a gap between said opposed arcuate flanges.

17. The clip of claim 16, wherein each of said opposed flanges is integrally molded with said elongated wire support and includes a base at said elongated wire support and a tip adjacent said gap.

18. The clip of claim 17, wherein opposed bases are separated by a distance D₁ and opposed tips are separated by a distance D₂ where D₁>D₂.

19. The clip of claim 18, wherein a wire held in said clip has a diameter D3 and D₁>D₃>D₂ so that said wire is captured between said opposed flanges but has clearance to slide along said wire abutment surface within said opposed flanges.

20. The clip of claim 19, wherein said mounting stud projects from a mounting side of said elongated wire support.
